(19) United States
(12) Patent Application Publication
(10) Pub. No.: US 2024/0265266 A1
(43) Pub. Date: Aug. 8, 2024

(54) CONTROL POLICY MODEL FOR REPRESENTING CAPABILITIES AND FOR EXCHANGING INFORMATION

(71) Applicant: SRI International, Menlo Park, CA (US)

(72) Inventors: Theodore Camus, Marlton, NJ (US); Zachary Seymour, Pennington, NJ (US); Bhoram Lee, Princeton, NJ (US); Andrew C. Silberfarb, Oceanside, CA (US); Supun Samarasekera, Skillman, NJ (US); Jonathan Brookshire, Princeton, NJ (US)

(21) Appl. No.: 18/434,435

(22) Filed: Feb. 6, 2024

Related U.S. Application Data
(60) Provisional application No. 63/443,617, filed on Feb. 6, 2023.

(51) Int. Cl. G06N 3/092; G06N 3/042

(52) U.S. Cl. CPC G06N 3/092; G06N 3/042

(57) ABSTRACT

In general, techniques are described for coordinating actions of a plurality of agents or subsystems using a machine learning system that implements a Capability Graph Network (CGN). In an example, a method includes generating a control policy model comprising a plurality of nodes and a plurality of edges interconnecting the plurality of nodes, wherein the plurality of nodes represents a plurality of agents or subsystems and the plurality of edges represent information exchange between the plurality of agents or subsystems; and encoding agent behavior control policy within the control policy model for executing to coordinate a plurality of the actions of the plurality of agents or subsystems.

This application claims the benefit of U.S. Patent Application No. 63/443,617, filed Feb. 6, 2023, which is incorporated by reference herein in its entirety.

### GOVERNMENT RIGHTS

This invention was made with Government support under contract number HR00112000009 awarded by the Defense Advanced Research Projects Agency (DARPA). The Government has certain rights in this invention.

### TECHNICAL FIELD

This disclosure is related to machine learning systems, and more specifically to a control policy model for representing capabilities and for exchanging information.

### BACKGROUND

Currently, there are a few key challenges in training swarms (large number) of autonomous agents. Training all agents' sensors and effectors simultaneously in a massive swarm is currently infeasible with existing deep learning methods and hardware. The traditional approach is to restrict swarm size or abandon reinforcement learning for programmatic approaches. Swarms may shrink or grow due to attrition, reinforcements, or other factors. Existing approaches typically train for many possible configurations or use programmatic solutions. Agents may power sensors on/off or change effectors, affecting control policies. Existing approaches address this challenge also by training for many configurations or by using programmatic solutions.

### SUMMARY

In general, techniques are described for a graph-based representation of agent capabilities and decision-making policies (collectively referred to herein as a control policy model) to facilitate training and control of swarms of autonomous agents. Vertices (nodes) in such a graph structure may represent agents (e.g., platforms, vehicles) and/or their subsystems (sensors and effectors, which are the components responsible for gathering information or taking actions within an agent). Nodes may represent different kinds of platforms or subsystems. Edges of the graph structure may represent connections between platforms or subsystems, indicating potential interactions or information flow. A restricted set of connections may limit edges to specific, meaningful relationships, simplifying learning and decision-making. In an aspect, a control policy model for representing capabilities and for exchanging information may be implemented as a Capability Graph Network (CGN). As described herein, a CGN is a reconfigurable control policy structure that embodies, in a flexible and tractable manner, the behavior of a scalable number of autonomous agents, with each agent being reconfigurable at the subsystem level. The CGN is designed to capture the specific capabilities and limitations of agents within a swarm, including their sensors, effectors, and potential interactions.

In some examples, the graph structure encodes decision-making rules and policies that may be used to guide agents' behaviors and coordination. The restricted connections in the CGN allow for learning to be decomposed into smaller, more manageable tasks, potentially addressing computational challenges.

In some examples, the CGN may accommodate dynamic changes in swarm size or individual agent configurations by adjusting the graph structure accordingly. As noted above, in the CGN, edges can depict the potential for information flow between different elements of the system. An edge between two sensor vertices indicates that data collected by one sensor can be shared with and utilized by the other sensor. Such edges may enable sensor fusion and a more comprehensive understanding of the environment,

The techniques may provide one or more technical advantages that realize at least one practical application. For example, CGNs could enable training and control of larger swarms than previously possible. CGNs may adapt to changing conditions and agent configurations. Distributed learning on the graph structure may be more computationally efficient than traditional deep learning approaches. The graph representation may potentially provide insights into agent behavior and decision-making. CGNs may provide autonomous swarm control in various domains, such as, but not limited to, robotics, unmanned aerial vehicles, and sensor networks. Edges between sensor and effector vertices enable coordinated actions based on shared sensor information. Information exchange through edges facilitates distributed decision-making within the swarm. Agents may leverage collective knowledge to make more informed and coordinated choices. The ability to share and integrate sensor data is another advantage that allows agents to adapt their behavior to changing conditions and make more informed decisions. In one example, a swarm of drones may be equipped with cameras and communication systems. A path of one or more edges between camera vertices may enable drones to share visual data, constructing a more comprehensive view of the environment.

In an example, a method includes generating a control policy model comprising a plurality of nodes and a plurality of edges interconnecting the plurality of nodes, wherein the plurality of nodes represents a plurality of agents or subsystems and the plurality of edges represent information exchange between the plurality of agents or subsystems; and encoding agent behavior control policy within the control policy model for executing to coordinate a plurality of the actions of the plurality of agents or subsystems .

In an example, a system for coordinating actions of a plurality of agents or subsystems includes processing circuitry in communication with storage media, the processing circuitry configured to execute a machine learning system configured to: generate a control policy model comprising a plurality of nodes and a plurality of edges interconnecting the plurality of nodes, wherein the plurality of nodes represents a plurality of agents or subsystems and the plurality of edges represent information exchange between the plurality of agents or subsystems; and encode agent behavior control policy within the control policy model for executing to coordinate a plurality of actions of the plurality of agents or subsystems.

In an example, non-transitory computer-readable storage media having instructions for coordinating actions of a plurality of agents or subsystems encoded thereon, the instructions configured to cause processing circuitry to: generate a control policy model comprising a plurality of nodes and a plurality of edges interconnecting the plurality of nodes, wherein the plurality of nodes represents a plurality of agents or subsystems and the plurality of edges represent information exchange between the plurality of agents or subsystems; and encode agent behavior control policy within the control policy model for executing to coordinate a plurality of actions of the plurality of agents or subsystems.

The details of one or more examples of the techniques of this disclosure are set forth in the accompanying drawings and the description below. Other features, objects, and advantages of the techniques will be apparent from the description and drawings, and from the claims.

### BRIEF DESCRIPTION OF DRAWINGS

FIGS. 1A and 1B depict a computing environment, in accordance with the techniques of the disclosure.

FIG. 2 is a detailed block diagram illustrating an example computing system, in accordance with the techniques of the disclosure.

FIG. 3 is a conceptual diagram illustrating situational awareness compression across layers of a hierarchy according to techniques of this disclosure.

FIG. 4 illustrates a top-down fine-tuning process, according to techniques of this disclosure.

FIG. 5 is a conceptual diagram illustrating an example of a graph based structure, according to techniques of this disclosure.

FIG. 6 is a flowchart illustrating an example mode of operation for a machine learning system, according to techniques described in this disclosure.

Like reference characters refer to like elements throughout the figures and description.

### DETAILED DESCRIPTION

A Capability Graph Network (CGN) may be designed to capture a control policy model for representing capabilities and for exchanging information. More specifically, a CGN may be designed to capture the specific capabilities and limitations of agents within a swarm, including their sensors, effectors, and potential interactions. In some examples, the graph structure is used to encode decision-making rules and policies, guiding agents' behaviors and coordination. In some examples, a CGN may be implemented as a Graph Neural Network (GNN), a type of deep learning architecture that operates on graph-structured data. The GNN may encode the agent behavior control policy within its structure and edge weights. Some edges may have strengths set manually, representing known relationships or constraints. Other edges may have strengths that are adjusted during a training process, allowing the GNN to adapt and learn optimal connections. The learning of the control policy may be decomposed into smaller functions that operate locally on individual nodes and edges, potentially improving computational efficiency and scalability. In some examples, a CGN may be implemented as one or more transformer models. Transformer models are deep learning models that may also be used to process graph-structured data and potentially learn relationships between capabilities and decision-making.

CGNs may learn complex, nonlinear relationships between agents and their capabilities, enabling more sophisticated control policies than traditional programmatic approaches. The ability to learn edge strengths allows the CGN to adapt to different swarm configurations and environments, enhancing CGN's flexibility. When implemented as GNN, distributed learning on the graph structure may potentially handle larger swarms than centralized deep learning methods. The graph-based representation may provide insights into the learned control policy, aiding in understanding and debugging. The GNN may accept data directly from sensors or observations about the environment as its primary input. The GNN may first project the raw input data into a lower-dimensional space using input preprocessors. Input preprocessing reduces dimensionality, making subsequent processing more efficient. Information may be exchanged and processed through message-passing between nodes (vertices) in the graph. Before transfer, features associated with nodes may be refined. In some cases, refinement may be performed using learned edge functions. In other words, the CGN may adapt how information is shared based on the CGN's training. Node features may represent agent capabilities and states, such as, but not limited to, types, ranges and sensitivities of sensors, actions that can be performed by effectors, internal states (e.g., position, energy, goals). Edge features may represent interaction potential or communication constraints, such as, but not limited to: bandwidth, latency, reliability, or trust or influence relationships.

The CGN may produce two types of outputs: updated features and action probabilities. Updated features may include refined features associated with nodes, capturing the collective knowledge and context from message passing. Action probabilities may include probabilities for each possible action associated with effectors, guiding agent behavior.

Information processing is distributed across the graph structure, enabling parallel computation and potentially enhancing scalability. Refining features before message-passing may improve the quality of information exchanged and lead to better decision-making.

Adaptable edge functions allow the CGN to learn optimal ways to share information based on experience, potentially improving performance. Agents may communicate not through explicit messages, but implicitly through their observed behaviors. Implicit communication via behavior may reduce the need for dedicated communication channels and potentially may enhance stealth.

Transmitting agents may have a “communications transmitter” vertex within their CGN that is responsible for packaging relevant features for transmission. The packaging function may be learned, allowing for optimized communication strategies. Receiving agents may have a “communications receiver” vertex, which is responsible for interpreting and unpacking features from received signals. An edge in the CGN connecting the two vertices represents information exchanged from one vertex to the other.

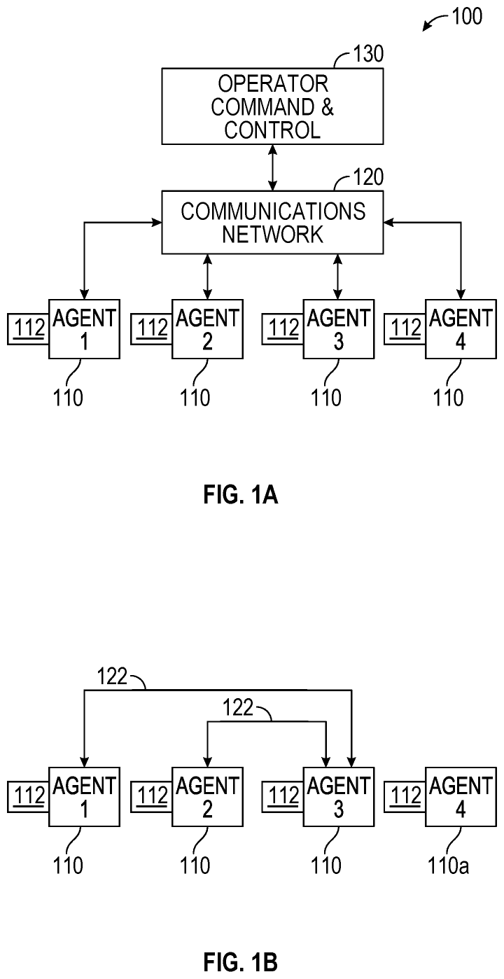

Referring now to FIG. 1A, illustrative computing environment 100 is depicted. The computing environment 100 may be referred to as an Agent Control (AC) system. As shown, computing environment 100 includes agents 110, a communications network 120, an Operator Command and Control (OCC) station 130 and an operating system or operating architecture (not shown) embedded within the system. In this exemplary implementation, the AC system 100 is shown with four agents, however, in another implementation the AC system 100 may include a swarm of any number of multiple agents 110. Control includes control over distributed elements according to aspects of the disclosure described below. Communication may be fully distributed, fully centralized or partially centralized or adaptively distributed as needed. An operator interacts with the command & control agent OCC station 130 to influence system behavior.

The agents 110 are platforms that include one or more subsystems. The subsystems may include sensors, communications relay antennae, actuators or other payloads. The subsystems may also include navigation subsystems. The agents 110 may be mobile, fixed or any combination thereof. The agents 110 may be any one or combination of ground, air, water, space and cyber operational agents. The agents 110 may include one or more sensors, such as, but not limited to visual and/or infrared (IR) cameras, chemical and/or biological detectors, radiation detectors, three-dimensional imaging systems, seismic sensors, acoustic sensors, radars, range finders, temperature or pressure sensors. In an aspect, ground agents may be wheeled or tracked ground vehicles having one or more sensors. In an aspect, aerial agents may be drones, balloon, rotor or fixed wing aircraft having one or more sensors. In an aspect, fixed position agents may be fixed platforms having one or more sensors, such as, but not limited to cameras and biologic and chemical sensors.

The agents 110 each includes a corresponding distributed intelligence module 112. The distributed intelligence module 112 includes hardware and software capable of receiving and executing a pre-trained CGN model, as well as receiving and processing commands from the OCC station 130 and from other agents 110, and is also capable of transmitting commands, sensor output and other messages to the OCC station 130 and other agents 110. In an aspect, each distributed intelligence module 112 may have its own CGN model 206′ (referred to herein after as CGN). In general, each CGN may be trained using different reinforcement learning (RL) techniques. In an aspect, OCC station 130 may have a machine learning system that has a centralized CGN that may be responsible for operation and control of the entire swarm of agents. The plurality of the aforementioned CGNs 206′ may model complex relationships and reasoning processes (e.g., agent behavior control policy). The behavior control policy may include, but is not limited to, commands to move the agent from one position to another position(s) and tasks to be performed at position(s). The movement command(s) may include waypoints, spatial curves to move along, spatial areas through which to move, and spatial volumes through which to move. The task command(s) may include, but are not limited to, gathering sensor data, manipulating or grasping objects, switching to alternative power states, positioning communications antennae to act as relays, delivering payloads, and the like.

The distributed intelligence module 112 may include an operator interface, processor, storage, actuators and agent interface(s) and to control agent operations, such as, but not limited to, movement, sensor operations, communications operations, manipulation, and payload delivery.

The communications network 120 includes communication links capable of transmitting data between the OCC station 130 and agents 110 and between agents 110 without the OCC station 130. In cases when centralized OCC station 130 and communication network 120 are both available, OCC station 130 may choose to update one or more agents 110 with an updated CGN model, which may result in the CGN model that has been retrained with the benefit of updated situational awareness information. In one aspect, the specialized CGN model may allow agents 110 to perform their tasks more effectively that has been specialized with behaviors optimized for the current situation than would be possible with an unspecialized generic model. The communication links may include wireless and/or wired systems, such as, but not limited to fiber optic, radiofrequency, free space optical, electrically wired systems, broadband, cellular, Wi-Fi, ZigBee, Bluetooth® (or other personal area network—PAN), Near-Field Communication (NFC), ultrawideband, satellite, enterprise, service provider and/or other types of communication systems.

The data communicated between the OCC station 130 and the agents 110 may include high level task and objective information, agent state information, lists of agents and presently assigned tasking, numeric weights describing the relative importance of different system performance criteria, direct real-time actuator commands, waypoints, environment and obstacle map information, sensor data, lists and descriptions of targets, performance metrics, and threat information.

The data communicated between the agents 110 may include high level task and objective information, agent state information, lists of agents and presently assigned tasking, numeric weights describing the relative importance of different system performance criteria, waypoints, environment and obstacle map information, sensor data, lists and descriptions of targets, performance metrics, and threat information.

Nodes of the CGNs may represent agents (individuals or vehicles) or their subsystems (sensors and effectors). Different node types distinguish platform or subsystem roles. Edges of the CGNs may represent potential interactions or information flow between nodes. Edges may be restricted to meaningful relationships for efficient learning and decision-making. Information may be propagated across the graph structures. Decision-making policies may be learned based on collective capabilities and context. The agents 110 may include a distributed intelligence module 112 may execute the agent behavior control policy. The behavior control policy may be a set of rules or guidelines that dictate how the agents 110 should behave in different situations. The behavior control policy may map observations of the environment to actions the agent should take.

In one aspect, the distributed intelligence module 112 may allow agents 110 to operate autonomously without direct control from the OCC station 130. In one example, OCC station 130 may not be available due to adversary action or natural disaster.

In another aspect, the distributed intelligence module 112 may allow agents 110 to operate autonomously without the communications network 120. In one example, communications network 120 may not be available due adversary disruption such as jamming, or natural disaster.

FIG. 1B illustrates an example of autonomous operation of a plurality of agents without the OCC station 130 and without the communications network 120. The distributed intelligence module 112 enables agents 110 to make decisions and act independently, even if communication with a central command is lost due to factors like attacks or natural disasters. The distributed intelligence module 112 may facilitate autonomous operation even when the primary communications network 120 is unavailable, either due to jamming or destruction. FIG. 1B illustrates such autonomous operation, showing agents 110 relying on shorter-range, individual communications 122 instead of the communications network 120. It should be noted that the disclosed techniques do not require every agent 110 to communicate with all others. Agents 110 may still operate effectively based on their individual understanding and limited communications 122 with nearby agents 110. For example, in FIG. 1B, agent 110a may operate completely isolated but may still leverage the distributed intelligence module 112 for autonomous behavior. A CGN model plays an important role in such autonomous operation. A CGN model may incorporate different communication scenarios (including limited or no communication) into its control policy behavior. In an aspect, a CGN model may continuously learn and adapt such policies through its training process.

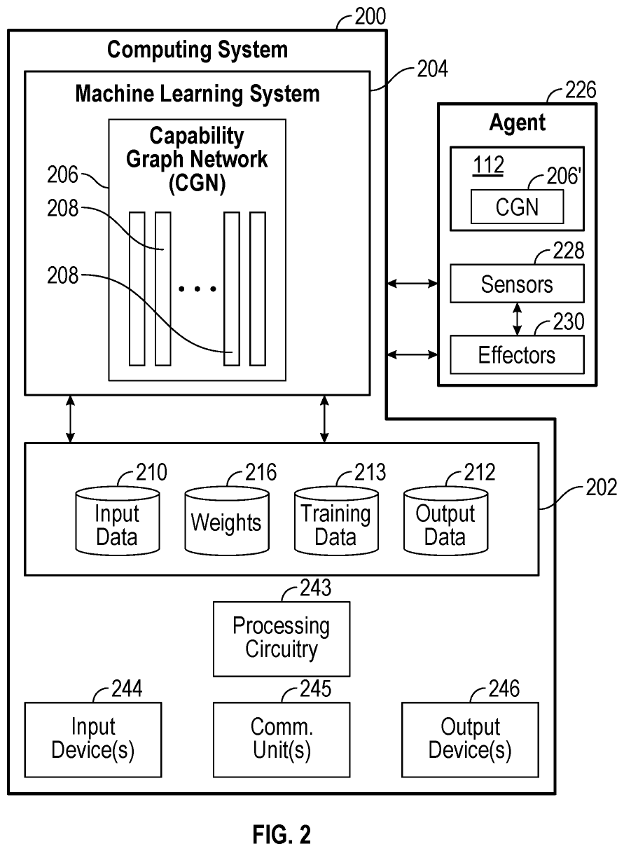

FIG. 2 is a block diagram illustrating an example computing system 200. In an aspect, computing system 200 may represent OCC station 130 shown in FIG. 1A. As shown, computing system 200 comprises processing circuitry 243 and memory 202 for executing a machine learning system 204 having a CGN 206 comprising a set of layers 208. CGN 206 and 206′may include any one or more of various types of graph-structured machine learning models, such as, but not limited to, GNN, Graph Convolutional Network (GCN) and Graph Attention Network (GAT).

Computing system 200 may be implemented as any suitable computing system, such as one or more server computers, workstations, laptops, mainframes, appliances, cloud computing systems, High-Performance Computing (HPC) systems (i.e., supercomputing) and/or other computing systems that may be capable of performing operations and/or functions described in accordance with one or more aspects of the present disclosure. In some examples, computing system 200 may represent cloud computing system 103, a server farm, and/or server cluster (or portion thereof) that provides services to client devices and other devices or systems. In other examples, computing system 200 may represent or be implemented through one or more virtualized compute instances (e.g., virtual machines, containers, etc.) of a data center, cloud computing system 103, server farm, and/or server cluster. In some examples, at least a portion of system 200 is distributed across a cloud computing system, a data center, or across a network, such as the Internet, another public or private communications network, for instance, broadband, cellular, Wi-Fi, ZigBee, Bluetooth® (or other personal area network—PAN), Near-Field Communication (NFC), ultrawideband, satellite, enterprise, service provider and/or other types of communication networks, for transmitting data between computing systems, servers, and computing devices.

The techniques described in this disclosure may be implemented, at least in part, in hardware, software, firmware or any combination thereof. For example, various aspects of the described techniques may be implemented within processing circuitry 243 of computing system 200, which may include one or more of a microprocessor, a controller, a digital signal processor (DSP), an application specific integrated circuit (ASIC), a field-programmable gate array (FPGA), Graphical Processing Unit (GPU), Neural Processing Unit (NPU) or circuity dedicated or optimized for neural net processing or equivalent discrete or integrated logic circuitry, or other types of processing circuitry. Processing circuitry 243 of computing system 200 may implement functionality and/or execute instructions associated with computing system 200. Computing system 200 may use processing circuitry 243 to perform operations in accordance with one or more aspects of the present disclosure using software, hardware, firmware, or a mixture of hardware, software, and firmware residing in and/or executing at computing system 200. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Memory 202 may comprise one or more storage devices. One or more components of computing system 200 (e.g., processing circuitry 243, memory 202) may be interconnected to enable inter-component communications (physically, communicatively, and/or operatively). In some examples, such connectivity may be provided by a system bus, a network connection, an inter-process communication data structure, local area network, wide area network, or any other method for communicating data. The one or more storage devices of memory 202 may be distributed among multiple devices.

Memory 202 may store information for processing during operation of computing system 200. In some examples, memory 202 comprises temporary memories, meaning that a primary purpose of the one or more storage devices of memory 202 is not long-term storage. Memory 202 may be configured for short-term storage of information as volatile memory and therefore not retain stored contents if deactivated. Examples of volatile memories include random access memories (RAM), dynamic random-access memories (DRAM), static random access memories (SRAM), and other forms of volatile memories known in the art. Memory 202, in some examples, may also include one or more computer-readable storage media. Memory 202 may be configured to store larger amounts of information than volatile memory. Memory 202 may further be configured for long-term storage of information as non-volatile memory space and retain information after activate/off cycles. Examples of non-volatile memories include magnetic hard disks, optical discs, Flash memories, or forms of electrically programmable memories (EPROM) or electrically erasable and programmable (EEPROM) memories. Memory 202 may store program instructions and/or data associated with one or more of the modules described in accordance with one or more aspects of this disclosure.

Processing circuitry 243 and memory 202 may provide an operating environment or platform for one or more modules or units (e.g., CGN 206), which may be implemented as software, but may in some examples include any combination of hardware, firmware, and software. Processing circuitry 243 may execute instructions and the one or more storage devices, e.g., memory 202, may store instructions and/or data of one or more modules. The combination of processing circuitry 243 and memory 202 may retrieve, store, and/or execute the instructions and/or data of one or more applications, modules, or software. The processing circuitry 243 and/or memory 202 may also be operably coupled to one or more other software and/or hardware components, including, but not limited to, one or more of the components illustrated in FIG. 2.

Processing circuitry 243 may execute machine learning system 204 using virtualization modules, such as a virtual machine or container executing on underlying hardware. One or more of such modules may execute as one or more services of an operating system or computing platform. Aspects of machine learning system 204 may execute as one or more executable programs at an application layer of a computing platform.

One or more input devices 244 of computing system 200 may generate, receive, or process input. Such input may include input from a keyboard, pointing device, voice responsive system, video camera, biometric detection/response system, button, sensor, mobile device, control pad, microphone, presence-sensitive screen, network, or any other type of device for detecting input from a human or machine.

One or more output devices 246 may generate, transmit, or process output. Examples of output are tactile, audio, visual, and/or video output. Output devices 246 may include a display, sound card, video graphics adapter card, speaker, presence-sensitive screen, one or more USB interfaces, video and/or audio output interfaces, or any other type of device capable of generating tactile, audio, video, or other output. Output devices 246 may include a display device, which may function as an output device using technologies including liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of display capable of generating tactile, audio, and/or visual output. In some examples, computing system 200 may include a presence-sensitive display that may serve as a user interface device that operates both as one or more input devices 244 and one or more output devices 246.

One or more communication units 245 of computing system 200 may communicate with devices external to computing system 200 (or among separate computing devices of computing system 200) by transmitting and/or receiving data, and may operate, in some respects, as both an input device and an output device. In some examples, communication units 245 may communicate with other devices over a network. In other examples, communication units 245 may send and/or receive radio signals on a radio network such as a cellular radio network. Examples of communication units 245 may include a network interface card (e.g., such as an Ethernet card), an optical transceiver, a radio frequency transceiver, a GPS receiver, or any other type of device that can send and/or receive information. Other examples of communication units 245 may include Bluetooth®, GPS, 3G, 4G, and Wi-Fi® radios found in mobile devices as well as Universal Serial Bus (USB) controllers and the like.

In the example of FIG. 2, machine learning system 204 may receive input data from an input data set 210 and may generate output data 212. Input data 210 and output data 212 may contain various types of information. For example, input data 210 may include sensor data, observations about the environment, and the like. Output data 212 may include information such as, but not limited to (i) updated features and (ii) action probabilities.

Each of layers 208 may include a corresponding set of artificial neurons. Layers 208 may include an input layer, a feature layer, an output layer, and one or more hidden layers, for example. Layers 208 may include convolutional layers, attention layers, and/or other types of layers. In a convolutional layer, each neuron of the convolutional layer processes input from neurons associated with the neuron's receptive field. The number of layers in CGN 206 may vary, depending on the complexity of the problem and the desired level of expressiveness.

Machine learning system 204 may process training data 213 to train the CGN 206 and/or agent CGN 206′, in accordance with techniques described herein. For example, machine learning system 204 may apply an end-to-end training method that includes processing training data 213. Training data 213 may include, but is not limited to, individual functions for each capability, control policy, and the like. Machine learning system 204 may process input data 210 to generate relevant updated features examples that may be included in the training data 213. Once trained, CGN 206 may be deployed as CGN 206′ to agent 226 (and other agents).

In an aspect, agent 226 may represent any of agents 110 shown in FIG. 1. As shown in FIG. 1, the OCC station 130 may communicate with the agents 110. Similarly, in FIG. 2, computing system 200 may communicate with agent 226. Features of CGN 206′ may represent key information about the agent's 226 state, observations, or intentions. Message content may be human-interpretable. In other words, humans may be able to understand the communicated information. By sharing features, agents 226 construct a collective understanding of the environment and their roles within the environment, forming a Common Operating Picture (COP). The COP may provide a shared understanding that may enable coordinated action and enhanced Situational Awareness (SA), allowing the swarm to adapt effectively to dynamic situations.

In one non-limiting example, a swarm of drones may be tasked with surveillance. Drones might communicate their locations, detected targets, or resource needs implicitly through their flight patterns or sensor 228 orientations. By observing these behaviors, other drones may infer certain information and may adjust their actions accordingly, coordinating surveillance efforts and maintaining SA.

Implicit communication lessens the need for explicit messages, potentially reducing bandwidth requirements and improving stealth. The disclosed system may function even if direct communication channels are disrupted, as long as agents 226 can observe each other's behaviors. Human operators may understand the communicated information, facilitating interaction and oversight.

Subsystems, which may include, but are not limited to, sensors 228 and/or effectors 230 on the same agent 226, may also exchange information directly without relying on external communication channels. Information may be shared through messages that contain relevant features or data extracted from sensor readings or intended for effector actions. In some cases, such messages may be understood by humans, facilitating debugging, analysis, or interaction with the agent. Sensors 228 may direct effectors 230 to gather specific data (e.g., a camera sensor directing a gimbal to focus on an object of interest).

Effectors 230 may inform sensors 228 about actions taken. Sensors 228 may share context about their readings, enhancing effector 230 decision-making. Effectors 230 may provide feedback to sensors 228, improving sensor data interpretation.

Direct communication may enable faster coordination and reaction times within the agent 226. Subsystems may preprocess (e.g., filter and prioritize information) before sharing it, minimizing the amount of data transmitted. In one non-limiting example, a robotic vehicle may be equipped with sensors 228, such as cameras or LiDAR, and effectors 230, such as a robotic arm. Cameras and LiDAR might share sensor data to generate a more comprehensive 3D map of the environment. The robotic arm may access the generated map to plan collision-free movement paths. The arm may also send feedback to sensors 228, indicating areas that require further scanning.

Agent CGNs 206′ may have the ability to modify their structure during operation, enabling adaptation to changing conditions or requirements. Agents 226 may expand their CGNs 206′ by incorporating additional CGNs as subgraphs, representing new or enhanced capabilities. Subgraphs may be of the same or different type as existing subgraphs, allowing for diverse capabilities to be added. Integration may involve creating edges between vertices in the added subgraph and other vertices in the agent CGN 206′, enabling information flow and coordination.

Agents 226 may adjust their capabilities and decision-making policies in response to new tasks or environments, enhancing their flexibility and effectiveness. CGNs 206 and 206′ may grow to accommodate more complex tasks or larger swarms without requiring complete retraining, promoting scalability. Damaged or malfunctioning subsystems can be potentially replaced or reconfigured, improving resilience.

In one non-limiting example, a drone may initially be tasked with surveillance. If assigned a new objective of delivering supplies, the machine learning system 204 may dynamically reconfigure the drone's CGN 206′. Machine learning system 204 may add a subgraph representing a subsystem or subsystem-carrying mechanism. Furthermore, machine learning system 204 may create edges linking the generated subgraph to navigation and obstacle avoidance systems. Dynamic reconfiguration may enable the drone to incorporate new capabilities and adapt its behavior accordingly.

Agents 226 may also reduce their CGNs 206′ by removing subgraphs and their associated edges. CGNs 206 may be reduced when capabilities are no longer needed. CGNs 206 may also be reduced when resources need to be conserved. Furthermore, CGNs 206 may be reduced when damaged subsystems are isolated.

In an aspect, agents 226 may dynamically modify connections between existing vertices. Adding edges represents increased information exchange or collaboration. Removing edges represents reduced information sharing or loss of capabilities. Agents 226 may streamline their decision-making processes by removing unnecessary capabilities or connections, reducing computational overhead. CGNs 206′ may scale down to operate within limited resource environments, conserving energy or bandwidth. Agents 226 may isolate malfunctioning subsystems by removing edges, preventing their negative impact on overall performance. The ability to add or remove edges may allow agents 226 to adapt their communication patterns and information sharing strategies in response to changing conditions or task requirements.

CGNs 206′ may be used to model teams of unmanned agents, where vertices represent either: individual agents within the team or specific capabilities or subsystems of the aforementioned agents.

Vertices of the graphical representation may represent platforms (e.g., drones, vehicles), jammers, communications payloads, geo-registration algorithms, or other relevant capabilities. Edges between vertices may depict potential information flow: (i) between agents 226 on the same team (intra-team communication), (ii) between subsystems within a single agent 226 (internal coordination). Separate CGNs 206′ may be used to model multiple teams, including those with adversarial relationships. CGNs 206′ may facilitate coordinated behavior within multi-agent teams by representing communication channels and information sharing patterns. In one example, machine learning system 204 may track and manage the capabilities of an individual agents 226. In another example, machine learning system 204 may track and manage the team as a whole (e.g., a swarm of agents), enabling optimal resource allocation and task assignment. Dynamic reconfiguration of CGNs 206′ allows teams to adapt to changing conditions, such as, but not limited to: loss of agents, new task requirements, adversarial actions. Modeling adversarial teams may help agents 226 predict and counter opposing strategies, enhancing their effectiveness in competitive or hostile environments.

In one non-limiting example, a team of drones may be tasked with reconnaissance and surveillance in a contested area. CGN 206′ may model drones' (e.g., agents' 226) communication links, sensor capabilities, and jamming systems. Machine learning system 204 may be used to coordinate information gathering, avoid detection, and deploy countermeasures. If a drone is lost, the CGN' 206 could be reconfigured to maintain team functionality.

CGNs 206′, as GNNs, may be optimized using adversarial neural network algorithms, enhancing their ability to learn in competitive or deceptive environments. Edges between allied agents may represent communication of accurate information.

Edges between adversarial agents may represent intentional dissemination of false information (disinformation). Disinformation may involve fake sensor signatures (radar, optical, SAR, etc.) and may be optimized for effectiveness using learning procedures.

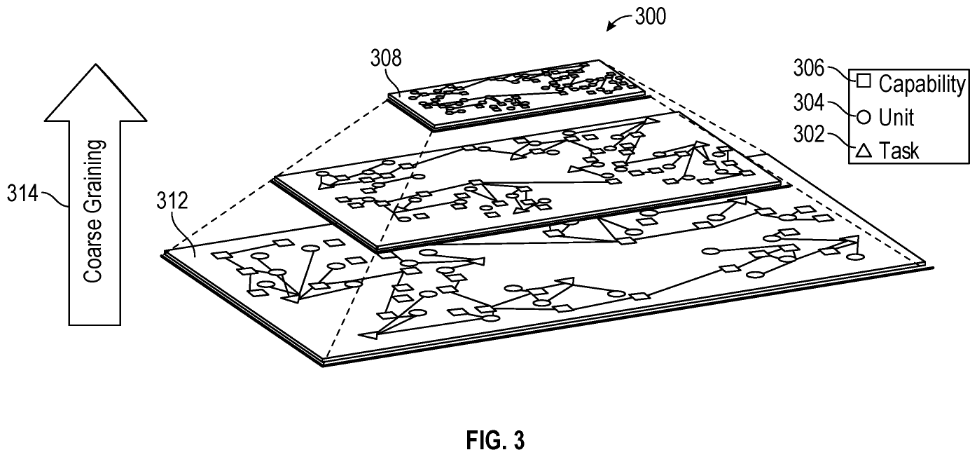

In an aspect, a layered Hierarchy Control Structure (HCS) may model team organization, with CGNs 206′ representing: agent 226 capabilities (subgraphs) and team networks of capabilities (combinations of subgraphs). Dynamic reconfiguration of HCS subgraphs and edges enables adaptation to changing tasks and conditions. Each layer (except the bottommost) may receive coarse-grained state information from the layer below. Each layer (except the bottommost) may provide tasking commands to the layer below. Task inputs may flow from higher layers to lower layers, as discussed below in conjunction with FIG. 3.

In an aspect, adversarial learning may help agents 226 learn effective strategies in the presence of deception or competition, making them more resilient to adversarial actions. In an aspect, explicit representation of disinformation within the CGN 206′ may allow agents 226 to reason about and potentially counter its effects, improving decision-making in deceptive environments. The layered HCS may enable efficient coordination and task allocation within multi-agent teams, promoting scalability and structured decision-making. In an aspect, the ability to reconfigure both CGNs 206 and the HCS allows for flexible adaptation to new tasks, changing team compositions, and unexpected events.

In summary, CGN 206′ offers powerful techniques to control and coordinate large-scale teams of autonomous agents 226, possessing the following key traits. CGN 206 may adapt to changing conditions, tasks, and agent configurations through dynamic reconfiguration. CGN 206′ may break down complex control policies into smaller, manageable pieces, enhancing computational efficiency. CGNs 206′ may accommodate potentially large numbers of agents 226, overcoming limitations of traditional deep learning methods. CGNs 206′ may enable individual agents 226 to modify their capabilities and decision-making processes by adding, removing, or modifying subgraphs within their CGNs 206′. Finally, CGNs 206′ may allow agents 226 to adjust information flow and coordination between their internal subsystems (sensors 228 and effectors 230) by dynamically adding or removing edges within their CGNs 206′.

CGNs 206′ address the computational constraints of training large swarms of agents 226 using traditional deep learning methods. CGNs 206′ accommodate changes in swarm size and agent configurations, making them suitable for real-world scenarios where agents may join, leave, or experience damage. CGNs 206′ may facilitate the learning of sophisticated control policies that capture the intricate relationships between agents 226 and their capabilities, leading to more effective swarm behavior. CGNs 206′ may provide a visual representation of agent capabilities and decision-making processes, aiding in understanding and debugging.

Implementation of CGNs 206′ as GNNs may leverage the power of GNNs to process and learn from graph-structured data, enabling the encoding of complex relationships between agents and their capabilities within a neural network framework. Capability Graph Neural Networks (CGNNs), which are CGNs implemented using GNNs, are compatible with state-of-the-art Reinforcement Learning (RL) techniques, allowing CGNNs to learn effective control policies through interaction with the environment. Training may be focused on specific subsystems or higher-level structures within the CGN 206, improving efficiency and addressing computational challenges associated with large-scale swarms.

In an aspect, GNNs may capture intricate relationships between agents and their capabilities, enabling the learning of sophisticated control policies that would be difficult to represent using traditional methods. Training may be distributed across the graph structure, potentially improving scalability and computational efficiency compared to centralized training approaches.

CGNs 206′ may model agent 226 capabilities and relationships between agents 226 using a restricted graph structure, intentionally limiting connections between nodes.

The structure of CGN 206 enables learning to be broken down into smaller, more manageable functions that operate on individual nodes or small subgraphs within the CGN 206. In purely deep learning approaches, large neural networks often learn complex behaviors in a monolithic fashion, facing challenges.

For example, training large networks may be computationally expensive. Purely deep learning approaches often struggle to scale effectively to large multi-agent systems. Understanding how decisions are made within large networks may be difficult.

Learning smaller, local functions is generally more computationally efficient and less prone to overfitting than training large, monolithic networks. Individual functions can be designed, trained, and updated independently, promoting modularity and maintainability.

The restricted graph structure provides insights into how agent 226 capabilities interact and contribute to overall behavior, facilitating understanding and debugging. Learning may be distributed across the CGN graph 206, potentially improving scalability for large-scale multi-agent systems.

For example, a drone may have capabilities for navigation and obstacle avoidance. The CGN 206′ may represent these capabilities as nodes with limited, meaningful connections. Learning may focus on individual functions for each capability, such as, but not limited to: navigating to waypoints, avoiding collisions, tracking moving objects, and the like. Such modular approach may simplify learning and improve interpretability compared to a single, monolithic network responsible for all aspects of drone behavior.

In an aspect, a single machine learning system 204 may be trained to learn a control policy that governs the behavior of agents 226 within a swarm. Such training may leverage global information and coordination, potentially leading to more optimal and efficient policies than those learned individually by agents 226. Once trained, the policy may be distributed to individual agents 226, who execute it autonomously without relying on a central controller. Such distribution provides several advantages, including but not limited to: resilience, scalability, adaptability, privacy. There is no single point of failure. If one agent 226 is lost or disabled, the swarm may continue to function without significant disruption.

The machine learning system 204 may be deployed to large numbers of agents without communication bottlenecks or computational constraints associated with a centralized controller. Agents 226 may react quickly to local changes in their environment without waiting for instructions from a central controller, enabling more responsive and adaptive behavior. In an aspect, sensitive information about individual agents 226 or their tasks need not be shared with a central controller, potentially enhancing privacy and security.

A swarm of drones may be tasked with search and rescue operations. A centralized machine learning system 204 may be trained using data on terrain, weather patterns, and search strategies. Once deployed, each drone may independently execute the policy to explore different areas, adapt to obstacles, and communicate findings without relying on continuous central control.

As noted above, CGNs 206′ represent communication channels between agents as edges within the graph. Communication restrictions or denials may be modeled by directly modifying edge properties, such as, but not limited to: removing edges between two or more nodes to simulate complete communication loss, reducing edge weights 216 to represent degraded communication quality, and introducing delays to model communication latency.

Dynamic modification of edge properties allows the CGN 206′ to adapt to changing communication conditions, such as, but not limited to: jamming, limited bandwidth, and agent failures. When implemented as GNNs, CGNs 206′ may learn by updating node and edge representations based on information exchanged across the graph. Components (nodes or subgraphs) trained within a GNN-based CGN 206′ may often be reused in different situations that involve modified graph structures or properties. For example, a node trained to perform obstacle avoidance in one scenario could potentially be transferred to a different scenario with different agent configurations or communication patterns. The techniques disclosed herein provide improved training efficiency by leveraging previously learned knowledge. The disclosed techniques also provide enhanced adaptability to new tasks or environments and provide potential for modular design of control policies.

As a non-limiting example, a swarm of drones may be operating in an area with sporadic jamming. CGN 206′ may dynamically adjust edge weights 216 to reflect communication quality, enabling drones to adapt their coordination strategies accordingly. A node trained for navigation in open areas may potentially be reused for navigation in more cluttered environments, even with different communication constraints.

Training a neural network for an entire swarm is impractical due to computational complexity and scalability issues. The number of connections in a neural net grows exponentially with the number of agents, making training excessively demanding. Adding or removing agents 226 would necessitate retraining the entire network, hindering adaptability. The disclosed techniques contemplate that each swarm member's sensors 228 and effectors 230 are represented as nodes in a graph. Information transfer between members is depicted as edges connecting those nodes.

Each node may encapsulate local control logic, enabling independent training and updates.

Decisions may be made based on local interactions and information exchange, fostering robustness and adaptability. Machine learning algorithms may efficiently train individual nodes or groups of nodes, addressing the computational challenges of whole-swarm training. The control elements within the capability graph, responsible for decision-making and behavior generation, may be trained using machine learning techniques. The disclosed techniques enable focused training on specific capabilities and interactions, making the learning process manageable. The disclosed techniques address the impracticality of whole-swarm neural network training. Furthermore, the disclosed techniques leverage a graph-based representation to model information flow and control logic in a distributed manner.

CGN 206 architecture is specifically designed to manage and coordinate the actions of a large number of autonomous agents 226. Decisions are made at the individual agent 226 level, rather than relying on a centralized controller.

Agents 226 and their interactions are modeled as nodes and edges in a graph, enabling efficient information sharing and coordination. CGN 206′ integrates a neural network component for learning control policies directly from data. CGN 206′ may learn and adapt to new environments and tasks without requiring explicit programming. CGN 206′ may potentially generalize learned behaviors to different swarm configurations and tasks. Combined, the aforementioned concepts offer a scalable and decentralized approach to controlling large swarms of agents 226 and the ability to learn control policies directly from data, fostering adaptability and generalization.

CGN 206′ may enable the use of deep learning algorithms in domains that were previously challenging due to scalability constraints and distributed nature. Traditional neural networks struggle to manage large numbers of interacting agents. The decentralized architecture CGN 206′ of makes it well-suited for problems involving multiple, interconnected entities.

CGN 206′ may rely on deep learning techniques; effective training is therefore important for good performance. Poorly implemented DL algorithms or insufficient training data may lead to suboptimal results.

Adapting to new problem definitions or data inputs may require retraining the CGN 206 to ensure CGN 206 maintains its effectiveness. CGN 206 offers an ability to expand the applicability of deep learning to complex, multi-agent systems. However, CGN 206 does not eliminate the fundamental principles of deep learning.

CGN 206 may tackle problems in domains like, but not limited to, robotics, traffic management, and smart grids, where numerous autonomous agents 226 interact and influence each other. Traditional deep learning methods often struggle with the sheer scale and intricate dynamics of such systems. CGNs 206 are advantageous in scenarios where centralized control is impractical or undesirable. For example, managing a swarm of drones for search and rescue, or coordinating a network of sensors for environmental monitoring, may benefit greatly from the distributed intelligence and adaptability offered by CGN 206. CGN 206 may handle larger and more complex datasets compared to traditional deep learning.

A larger problem size opens up possibilities for tackling bigger challenges in areas like, but not limited to, drug discovery, materials science, and financial modeling. The modular nature of CGN 206 allows for parallel training and execution, potentially leading to faster processing times and more efficient decision-making in real-time applications.

FIG. 3 is a conceptual diagram illustrating situational awareness compression across layers of a hierarchy 300 according to techniques of this disclosure.

The CGN 206 may be implemented using a GNN, a type of neural network designed for graph-structured data. GNN enables the use of powerful graph learning techniques. Each distinct node type may be represented by a small neural network. These networks may transform initial state inputs (e.g., coordinates, targeting info, radar coverage) into embedding vectors, capturing relevant information about the node's state. Each distinct edge type may also be represented by a small neural network. These neural networks may transform embedding vectors between nodes, taking into account the edge type (e.g., has capability, permissive communications, denied communications).

The GNN may be trained using Deep Reinforcement Learning (DRL), a technique where an agent 226 learns to make decisions through trial and error in an environment. The agent 226 may interact with the environment, receive feedback (rewards or penalties), and may update a policy to maximize long-term rewards. After multiple training rounds, the agent nodes in the GNN may generate a distribution over possible actions and their parameters (the policy). The generated policy may guide the actions of agents 226 in the real world. The learned policy may control teams of varying sizes, in diverse situations, and with different tasks, based on their CGN representations. The policy may adjust to changing conditions and new information as it continues to learn. GNNs may handle large and complex graphs, making them suitable for multi-agent systems with many interacting entities. The specific architecture of the GNN (e.g., number of layers, types of neural networks used for nodes and edges) may significantly impact performance. The choice of DRL algorithm (e.g., Q-learning, Deep Q-Networks, Policy Gradient methods) also may play an important role in the effectiveness of policy learning.

When the CGN 206 is implemented as a GNN, tasks 302 may be organized into a hierarchical structure 300, with higher layers 308 representing more abstract goals and lower layers 312 containing more specific, actionable tasks 302. Tasks 302 may be managed and modified independently, enhancing adaptability and reusability. Complex tasks 302 may be decomposed into smaller, more manageable subtasks. Information about the environment and system state may be summarized and passed up the hierarchy 300, providing higher levels 308 with a broader understanding of the situation. Coarsening 314 situation awareness up the hierarchy 300 enables more strategic decision-making. “Coarse graining” is a process of summarizing and compressing information by discarding some details and focusing on the most important features. “Coarse graining” implies that the remaining information is represented at a more abstract level. The term “situational awareness”, as used herein, refers to the understanding of the surrounding environment and the ability to interpret that information to make informed decisions.

Generic tasks 302 may be defined at higher levels 308 and then may be parameterized with specific details as they are passed down the hierarchy 300. Parameterizing generic task distribution down the hierarchy 300 allows for flexibility and adaptability in task execution. It should be noted that teams of agents 226 may be formed based on their capabilities 306, enabling efficient collaboration and task completion. The disclosed system may be trained to learn and execute hierarchical policies, which specify how to achieve goals through a sequence of actions. The disclosed techniques may handle complex tasks 302 with many subtasks and may adjust to changing conditions and goals. Furthermore, the disclosed techniques may decompose tasks 302 and allocate resources effectively and may handle errors and failures gracefully. Common applications of the disclosed techniques may include robotics tasks, such as, but not limited to, navigation, object manipulation, and teamwork. Furthermore, the disclosed techniques may be applied in autonomous systems, such as, but not limited to, self-driving cars, drones, and other unmanned vehicles, and in business process management helping to coordinate complex workflows and activities. Understanding how information is shared and processed within the hierarchy 300 is important. The mechanisms for forming and coordinating teams of agents 226 are important for effective collaboration. The methods used to train and adapt hierarchical policies may significantly impact performance.

In an aspect, a gridded, multi-layer map represents spatially extended features like terrain and communications denial. The map may be divided into cells for efficient data storage and processing.

A capability graph (e.g., CGN 206) implemented as GNN may represent the status, capabilities 306, and interactions of units 304. Nodes may represent units 304, capabilities 306, or tasks 302. Edges may represent relationships between units 304 (such as, but not limited to, assigned tasks, communication links, and the like). Embedding vectors at each node and map cell may capture relevant status information. Lower layers 312 capture fine-grained details of all units 304 and actions. Lower layers 312 may update at full simulation speed for real-time awareness. Higher layers 308 may capture summarized information about larger units 304 and their status. Higher layers 308 may update at coarser time intervals for strategic decision-making. The illustrated hierarchical representation 300 combines map-based features with graph-based relationships for a comprehensive view. Large numbers of units 304 and features may be handled through hierarchical representation 300. Hierarchical representation 300 may adjust the level of detail based on task 302 requirements and computational resources. Hierarchical representation 300 may facilitate information sharing and decision-making across layers. Understanding how information is aggregated and passed between layers is important. The choice of embedding techniques may significantly impact performance. Effective visualization tools may aid in understanding the situational awareness representation.

As discussed above, CGN 206 is a graph-based representation of agents 226 and their capabilities, with specific rules governing connections between nodes. The CGN's 206 structure breaks down learning into smaller, more manageable tasks, making it easier to train compared to purely deep learning approaches. Edge properties may be modified to represent restricted or denied communications between agents 226, allowing for realistic simulations of communication challenges.

In an aspect, trained CGN 206 components may be reused in different situations with modified graph structures and properties, promoting efficiency and adaptability. The CGN's 206 organization may guide learning, potentially leading to better model generalization and interpretability. In an aspect, CGN 206 may directly capture communication constraints, essential for real-world scenarios with limited connectivity. CGNs 206 may be adaptable to various situations through graph modifications, maximizing the value of trained components. In an aspect, CGNs 206 may be used for coordination and decision-making in systems with multiple interacting agents 226.

In one example, CGNs 206 may be used for modeling and optimizing network performance under varying conditions and constraints. CGNs 206 may also manage interactions and resource allocation in decentralized systems. CGNs 206 may also be used in developing systems that may adjust to changes in their environment and communication capabilities. The choice of graph learning algorithms may significantly impact the CGN's 206 effectiveness. CGNs 206 may be combined with reinforcement learning techniques to enable agents 226 to learn optimal behaviors in complex environments.

Each layer in the hierarchy 300 may receive state input from the layer below, which is a summarized version of the more detailed information at the lower level. Information flow may provide tasking commands to the layer below, guiding the actions of agents at that level.

It should be noted that each layer may learn policies, which are essentially rules or guidelines for making decisions and taking actions. These policies may be aimed at achieving coordinated execution of tasks 302 to accomplish long-term goals assigned by higher layers 308. Hierarchical structure 300 may handle complex tasks 302 by breaking them down into smaller, more manageable subtasks across multiple layers.

Higher layers 308 may focus on strategic goals without being overwhelmed by low-level details, promoting efficient decision-making. Layers may adjust their policies in response to changing conditions and feedback from other layers, leading to more resilient and adaptive behavior.

Effective communication and coordination mechanisms may be important for smooth information flow and task alignment between layers. The algorithms used to train policies may also play an important role in the system's ability to learn effective strategies.

In an aspect, nodes may be added to tailor the CGN 206 to specific team structures, tasks 302, and operational areas, ensuring CGN 206 accurately reflects team context. It should be noted that communication nodes may include short-range nodes for within-team communication, enabling cooperation and collaboration. Furthermore, communication nodes may include long-range nodes for situational awareness sharing across teams at the same level, facilitating broader coordination.

Edges represent potential data flows between communication nodes, defining information exchange pathways. Policies may be formulated within the CGN 206, incorporating agent capabilities 306, information-sharing rules, and coordination constraints. Auxiliary functions for skill combination may facilitate seamless integration of reusable skills, promoting efficient and flexible task execution. In other words, agent behavior control policy may be encoded within the CGN 206. Machine learning system 204 may execute the agent behavior control policy using CGN 206 to coordinate actions of the plurality of agents 226 or subsystems.

In an aspect, policies may guide the breakdown of long-term goals into sequences of shorter-term tasks 302 for individual agents 226, ensuring coordinated progress towards overall objectives. CGN 206 accurately captures team dynamics and communication patterns. In an aspect, policies may promote effective collaboration and information sharing within and across teams. CGNs 206 may be customized for different team structures and tasks, enhancing versatility. Skill combinations may enable efficient task 302 execution and knowledge transfer. The complexity of models for short-range and long-range communications may significantly impact performance and realism. Learning effective policies within a multi-agent, communication-constrained environment is a challenging task, requiring careful algorithm selection and training data.

Agents 226 and their capabilities may be modeled as small graph networks, minimizing impact on policy complexity when changes occur.

Each agent-capability connection may be a simple two-node, one-edge graph, allowing for flexible addition or removal of capabilities 306. The illustrated system may seamlessly accommodate adding new instances of known units 304 and losing units 304 due to attrition or re-tasking. The CGN's 206 structure supports quick integration of previously unseen agent types, as well as new team configurations. Adding or removing units 304 may involve creating or deleting small graph networks within the CGN 206. Such operations minimally affect overall graph structure and policy complexity. Incorporating new agent types may require adding new node types and edges to the CGN 206. Such incorporation does not require extensive policy re-training due to localized graph updates. Adaptation to new team configurations may be achieved by adjusting connections between agent-capability graphs.

Policy may remain adaptable as the policy operates on relationships rather than fixed structures. More specifically, the disclosed system may dynamically adjust to changing resources and mission requirements.

The disclosed techniques may effectively handle varying numbers of agents 226 and capabilities 306. The disclosed techniques provide potential to transfer learned policies to new scenarios with different agent compositions. Thorough assessment in dynamic environments is important to verify adaptability and performance.

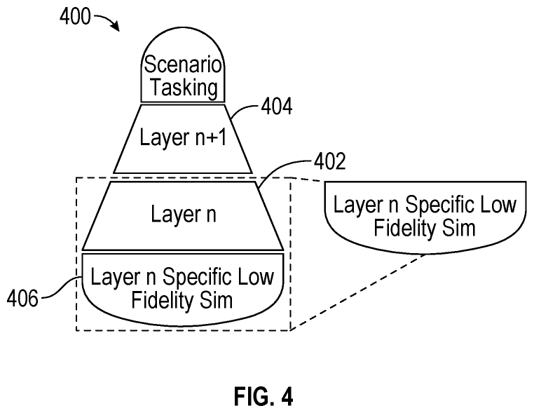

FIG. 4 illustrates a top-down fine-tuning process according to techniques of this disclosure. The purpose of the fine-tuning process 400 is to enhance coordination between independently trained teams that might exhibit suboptimal interactions. As shown in FIG. 4, pairs of layers may be fine-tuned in a top-down manner using hierarchical reinforcement learning. Layers N 402 and N+1 404 may be unfrozen, allowing for policy updates. Layers N 402 and N+1 404 may be jointly trained on new objectives to refine coordination. Layer N+1 404 may learn to issue tasks 302 that effectively coordinate multiple teams in layer N 402. Layer N 402 may continue issuing tasks to the lower-fidelity simulation of layer N−1 406.

Top-down fine tuning 400 addresses potential coordination issues arising from independent layer training. Top-down fine-tuning 400 may tailor coordination strategies to specific objective requirements. Top-down fine-tuning 400 enables efficient and coordinated learning across multiple layers. The number of layers involved in fine-tuning 400 may vary depending on system complexity and desired coordination levels. Well-designed scenarios are important for effective fine-tuning 400 and ensuring learned coordination generalizes to real-world challenges. Assessing coordination improvement after fine-tuning 400 is important to measure impact of the fine-tuning process 400. Top-down fine-tuning 400 may interact with the CGN 206 representation, as coordination is influenced by agent capabilities 306 and communication constraints. Top-down fine-tuning 400 may be positioned as a complementary process to basic training, refining coordination after initial individual layer training. Potential applications of the top-down fine-tuning 400 may include, but are not limited to: teams of robots, autonomous vehicles, or other intelligent agents requiring coordinated actions.

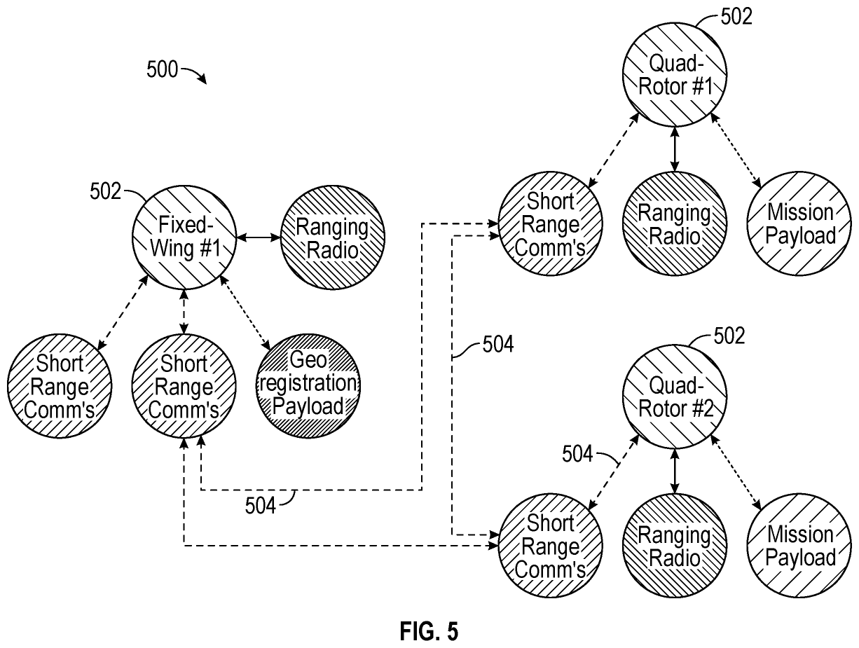

FIG. 5 illustrates a graph-based structure according to techniques of this disclosure. More specifically, FIG. 5 illustrates a graph-based structure 500 that may be used to represent the system or team of agents. The nodes 502 in graph 500 represent the agents 226, platforms, sensors 228, and effectors 230, while edges 504 represent the information exchange (e.g., communications) between them. The graph-based structure 500 may be easily modified to accommodate new units or changes in the size of the swarm. Different platforms and payloads may be mixed and matched without any retraining.

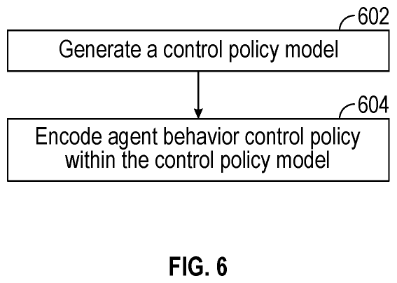

FIG. 6 is a flowchart illustrating an example mode of operation for a machine learning system, according to techniques described in this disclosure. Although described with respect to computing system 200 of FIG. 2 having processing circuitry 243 that executes machine learning system 204, mode of operation 600 may be performed by a computation system with respect to other examples of machine learning systems described herein.

In mode operation 600, processing circuitry 243 executes machine learning system 204. Machine learning system 204 may generate a control policy model comprising a plurality of nodes and a plurality of edges interconnecting the plurality of nodes (602). The plurality of nodes may represent a team of agents and the plurality of edges may represent information exchange between the plurality of agents (602). Machine learning model 204 may next encode agent behavior control policy within the control policy model (604). In an aspect, the policy may remain adaptable as the policy operates on relationships rather than fixed structures. In an aspect, the agent behavior control policy may govern the behavior of agents within a swarm.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components or integrated within common or separate hardware or software components.

The techniques described in this disclosure may also be embodied or encoded in computer-readable media, such as a computer-readable storage medium, containing instructions. Instructions embedded or encoded in one or more computer-readable storage mediums may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

What is claimed is:

1. A method for coordinating actions of a plurality of agents or subsystems, the method comprising:
generating a control policy model comprising a plurality of nodes and a plurality of edges interconnecting the plurality of nodes, wherein the plurality of nodes represents a plurality of agents or subsystems and the plurality of edges represent information exchange between the plurality of agents or subsystems; and
encoding agent behavior control policy within the control policy model for executing to coordinate a plurality of actions of the plurality of agents or subsystems.

2. The method of claim 1, wherein the plurality of nodes represents sensors and effectors and wherein the plurality of edges represents information exchange between the sensors and the effectors.

3. The method of claim 1, wherein the control policy model comprises a Capability Graph Network (CGN).

4. The method of claim 3, wherein the CGN comprises a graph-based neural network and wherein the method further comprises:
executing the agent behavior control policy using the graph-based neural network to coordinate actions of the plurality of agents or subsystems.

5. The method of claim 4, wherein sensor data and one or more observations about an environment surrounding the plurality of agents comprise input to the graph-based neural network.

6. The method of claim 4, further comprising:
dynamically reconfiguring the graph-based neural network, based on one or more changes in the environment, by adding and/or removing a subgraph of the graph-based neural network and by adding/removing one or more edges associated with added and/or removed subgraph.

7. The method of claim 4, wherein generating the graph-based neural network comprises:
generating a plurality of graph-based neural networks, wherein each of the plurality of graph-based neural networks represents an individual agent of one or more pluralities of agents.

8. The method of claim 7, wherein two or more of the teams of agents are split into adversarial teams.

9. The method of claim 4, further comprising:
organizing a plurality of tasks to be performed by the team of agents into a hierarchical structure having one or more lower levels and one or more higher levels.

10. The method of claim 9, further comprising:
summarizing information about an environment obtained by the one or more lower levels; and
passing the summarized information up the hierarchical structure to the one or more higher levels.

11. The method of claim 4, further comprising:
jointly training two or more layers of the graph-based neural network using hierarchical reinforcement learning to refine coordination within the team of agents.

12. The method of claim 4, further comprising:
generating, by the graph-based neural network, an output comprising at least one of:
updated features associated with one or more of the plurality of nodes and one or more probabilities associated with one or more actions to be performed by the team of agents.

13. The method of claim 1, wherein the agent behavior control policy comprises a decentralized control policy independently executed by the plurality of agents.

14. The method of claim 1, further comprising:
modifying one or more properties of the one or more of the plurality of edges to represent communication restrictions between two or more of the plurality of nodes.

15. A computing system for coordinating actions of a plurality of agents or subsystems:
processing circuitry in communication with storage media, the processing circuitry configured to execute a machine learning system configured to:
generate a control policy model comprising a plurality of nodes and a plurality of edges interconnecting the plurality of nodes, wherein the plurality of nodes represents a plurality of agents or subsystems and the plurality of edges represent information exchange between the plurality of agents or subsystems; and
encode agent behavior control policy within the control policy model for executing to coordinate a plurality of actions of the plurality of agents or subsystems.

16. The system of claim 15, wherein the plurality of nodes represents sensors and effectors and wherein the plurality of edges represents information exchange between the sensors and the effectors.

17. The system of claim 15, wherein the control policy model comprises a Capability Graph Network (CGN).

18. The system of claim 17, wherein the CGN comprises a graph-based neural network and wherein the machine learning system is further configured to:
execute the agent behavior control policy using the graph-based neural network to coordinate actions of the plurality of agents or subsystems.

19. The system of claim 18, wherein the machine learning system is further configured to:
dynamically reconfigure the graph-based neural network, based on one or more changes in the environment, by adding and/or removing a subgraph of the graph-based neural network and by adding/removing one or more edges associated with added and/or removed subgraph.

20. Non-transitory computer-readable storage media having instructions for coordinating actions of a plurality of agents or subsystems, the instructions configured to cause processing circuitry to:
generate a control policy model comprising a plurality of nodes and a plurality of edges interconnecting the plurality of nodes, wherein the plurality of nodes represents a plurality of agents or subsystems and the plurality of edges represent information exchange between the plurality of agents or subsystems; and
encode agent behavior control policy within the control policy model for executing to coordinate a plurality of actions of the plurality of agents or subsystems.
